(19) United States
(12) Patent Application Publication
(10) Pub. No.: US 2022/0044310 A1
(43) Pub. Date: Feb. 10, 2022

(54) SYSTEM, CONTROL APPARATUS, CONTROL METHOD, AND NON-TRANSITORY STORAGE MEDIUM

(71) Applicant: NEC Corporation, Minato-ku, Tokyo (JP)

(72) Inventor: Yuji TAHARA, Tokyo (JP)

(73) Assignee: NEC Corporation, Minato-ku, Tokyo (JP)

(21) Appl. No.: 17/297,242

(22) PCT Filed: Nov. 28, 2019
(86) PCT No.: PCT/JP2019/046591

§ 371 Date: May 26, 2021

(30) Foreign Application Priority Data
Dec. 12, 2018 (JP) 2018-232701

(51) Int. Cl. G06Q 30/06; G06Q 10/08

(52) U.S. Cl. CPC G06Q 30/0643; G06Q 10/087; G06Q 30/0639

(57) ABSTRACT

A system (10) includes a display panel (30) and a control apparatus (40). The display panel (30) is placed on a shelf. The control apparatus (40) controls a display content of the display panel (30). The control apparatus (40) switchingly displays a display content for a clerk and a display content for a customer on the display panel (30). The display content for a customer includes, for example, one or more pieces of price label information. The display content for a clerk includes, for example, change information indicating a change in arrangement of a product on the shelf.

### TECHNICAL FIELD

The present invention relates to a system, a control apparatus, a control method, and a computer program.

### BACKGROUND ART

An electronic shelf label can change a display content by performing transmission and reception with a server.

Patent Document 1 describes an electronic shelf label provided for each product classification being exhibited on an exhibition shelf With a technique in Patent Document 1, different shelf label management numbers are given to all shelf labels. Then, a product is determined by the shelf label management number, and an inventory state of the product is displayed on a display.

### RELATED DOCUMENT

### Patent Document

[Patent Document 1] Japanese Patent Application Publication No. 2016-177744

### SUMMARY OF THE INVENTION

### Technical Problem

However, with the technique in Patent Document 1, an exhibition change of a product causes trouble. For example, with the technique in Patent Document 1, since an electronic shelf label is provided for each product classification, a clerk has to move or replace the electronic shelf label according to an exhibition position of each product.

The present invention has been made in view of the problem described above. An object of the present invention is to provide a technique for reducing trouble during an exhibition change of a product.

### Solution to Problem

A system according to the present invention includes:

a display panel placed on a shelf; and

a control apparatus that controls a display content of the display panel, wherein

the control apparatus switchingly displays a display content for a clerk and a display content for a customer on the display panel.

A control apparatus according to the present invention is

a control apparatus that controls a display content of a display panel placed on a shelf, wherein

the control apparatus switchingly displays a display content for a clerk and a display content for a customer on the display panel.

A program according to the present invention is

a computer program for achieving a control apparatus that controls a display content of a display panel placed on a shelf, and

the program causes a computer to function as the control apparatus that switchingly displays a display content for a clerk and a display content for a customer on the display panel.

A control method according to the present invention is

a control method of controlling a display content of a display panel placed on a shelf, the control method including

by a computer, switchingly displaying a display content for a clerk and a display content for a customer on the display panel.

### Advantageous Effects of Invention

The present invention can reduce trouble during an exhibition change of a product.

### BRIEF DESCRIPTION OF THE DRAWINGS

The above-described object, the other objects, features, and advantages will become more apparent from a suitable example embodiment described below and the following accompanying drawings.

FIG. 1 is a diagram illustrating a configuration of a system according to a first example embodiment.

FIG. 2 is a diagram illustrating a use environment and a display content of a display panel according to the first example embodiment.

FIG. 3 is a diagram illustrating a display fixture equipped with a plurality of shelves.

FIG. 4 is a diagram illustrating a display fixture equipped with a plurality of shelves.

FIG. 5 is a diagram illustrating a configuration of a control apparatus according to the first example embodiment.

FIG. 6 is a diagram illustrating a configuration of product information according to the first example embodiment.

FIG. 7 is a diagram illustrating a configuration of exhibition data according to the first example embodiment.

FIG. 8 is a diagram illustrating arrangement of a product based on the product information in FIG. 6 and the exhibition data in FIG. 7.

FIG. 9 is a diagram illustrating an explanatory note of a display of each product in FIG. 8.

FIG. 10 is a diagram illustrating a display panel on which price label information is displayed, based on the product information in FIG. 6 and the exhibition data in FIG. 7.

FIG. 11 is a diagram illustrating a computer for achieving the control apparatus.

FIG. 12 is a diagram illustrating a configuration of a control apparatus according to a second example embodiment.

FIG. 13 is a diagram illustrating a configuration of exhibition data generated in a first processing example.

FIG. 14 is a diagram illustrating an operation screen when a face is reduced.

FIG. 15 is a diagram illustrating a configuration of exhibition data being associated with product arrangement in FIG. 14.

FIG. 16 is a diagram illustrating an operation screen when a face is enlarged.

FIG. 17 is a diagram illustrating a configuration of exhibition data being associated with product arrangement in FIG. 16.

FIG. 18 is a diagram illustrating an operation screen when a product is deleted.

FIG. 19 is a diagram illustrating a configuration of exhibition data being associated with product arrangement in FIG. 18.

FIG. 20 is a diagram illustrating an operation screen when a product is inserted.

FIG. 21 is a diagram illustrating a configuration of exhibition data being associated with product arrangement in FIG. 20.

FIG. 22 is a diagram illustrating a configuration of a system according to a third example embodiment.

FIG. 23 is a diagram illustrating a display screen of a clerk terminal for switching a display content of a display panel.

FIG. 24 is a diagram illustrating a configuration of second exhibition data.

FIG. 25 is a diagram illustrating arrangement of a product based on the exhibition data in FIG. 24.

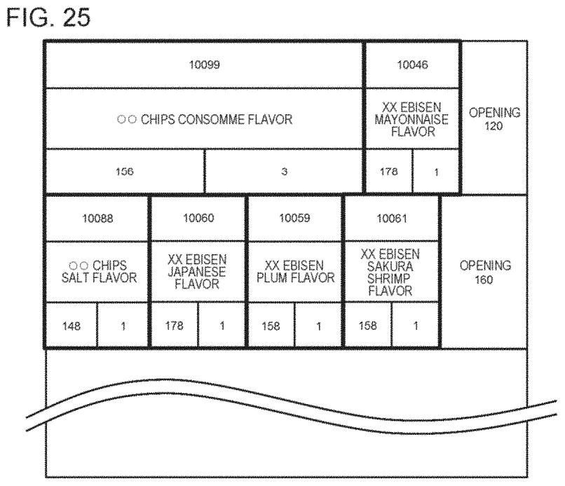

FIG. 26 is a flowchart illustrating processing performed by a display data generation unit in order to display a display content for a clerk on the display panel.

FIG. 27 is a diagram illustrating a display panel on which change information indicating taking out a product is displayed.

FIG. 28 is a display screen of a clerk terminal for transmitting switch information to a control apparatus.

FIG. 29 is a diagram illustrating a display panel on which change information indicating reducing a face of a product is displayed.

FIG. 30 is a diagram illustrating a display panel on which change information indicating reducing a face of a product is displayed.

FIG. 31 is a diagram illustrating a display panel on which change information indicating moving a product within the same shelf is displayed.

FIG. 32 is a diagram illustrating a display panel on which change information indicating moving a product to a different shelf is displayed.

FIG. 33 is a diagram illustrating a display panel on which change information indicating enlarging a face of a product is displayed.

FIG. 34 is a diagram illustrating a display panel on which change information indicating introducing a product is displayed.

FIG. 35 is a diagram illustrating a display content for a customer after an exhibition change.

FIG. 36 is a diagram illustrating a configuration of a system according to a fourth example embodiment.

FIG. 37 is a diagram illustrating a use environment and a display content of a display panel according to the fourth example embodiment.

FIG. 38 is a diagram illustrating a display panel on which a caution is displayed.

FIG. 39 is a diagram illustrating a display screen of a clerk terminal for managing an exhibition time limit.

FIG. 40 is a diagram illustrating a display panel on which a display encouraging takeout of a product is performed.

### DESCRIPTION OF EMBODIMENTS

Hereinafter, example embodiments of the present invention will be described with reference to the drawings. In all the drawings, the same constituents will be referred to with the same numerals, and the description thereof will not be repeated.

### First Example Embodiment

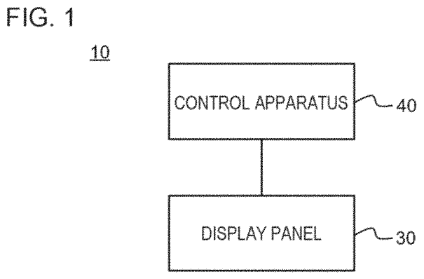

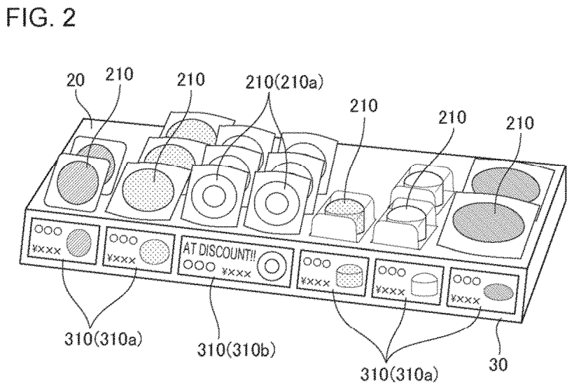

FIG. 1 is a diagram illustrating a configuration of a system 10 according to a first example embodiment. FIG. 2 is a diagram illustrating a use environment and a display content of a display panel 30 according to the first example embodiment. The system 10 according to the present example embodiment includes the display panel 30 and a control apparatus 40. The display panel 30 is placed on a shelf 20. The control apparatus 40 controls a display content of the display panel 30. Then, the control apparatus 40 determines a display region 310 of each piece of price label information in the display panel 30 by use of exhibition data of the shelf 20. Description is given in detail below.

The shelf 20 is placed in a store such as a supermarket and a convenience store. At a store, a product 210 is arranged on the shelf 20, and, thereby, the product 210 is exhibited to a customer. For example, identical products are aligned in a depth direction from a near side when the shelf 20 is viewed from a front. However, identical products may be piled up in an up-down direction when the shelf 20 is viewed from the front, or the product 210 may be exhibited in another way. The display panel 30 is a display of liquid crystal, organic EL, electronic paper, or the like, and at least temporarily displays price label information of the product 210. Then, a customer can check the price label information and purchase the product 210.

The shelf 20 is possibly a part of a display fixture. A wagon, a rack, and the like are cited as the display fixture. The display fixture may include a plurality of the shelves 20. In this case, the display panel 30 may be placed for each of all the shelves 20 of the display fixture, or the display panel 30 may be placed for some of the shelves 20. Note that, the shelf 20 is not limited to a shelf provided in a display fixture. The shelf 20 may be, for example, built in a wall.

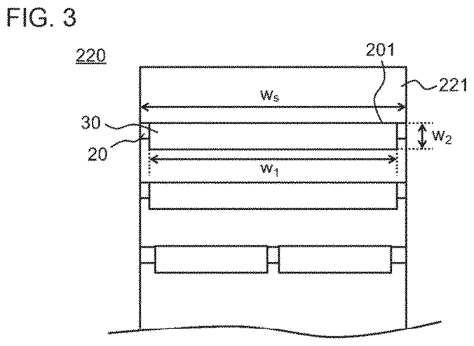

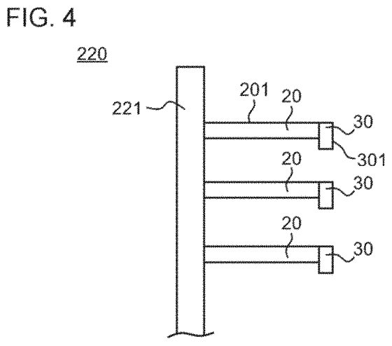

FIGS. 3 and 4 are diagrams illustrating a display fixture 220 equipped with a plurality of the shelves 20. FIG. 3 illustrates a state where the display fixture 220 is viewed from a front, and FIG. 4 illustrates a state where the display fixture 220 is viewed from a side. A product can be exhibited by use of such a display fixture 220. In an example of the present Figure, the display fixture 220 includes a back plate 221 and a plurality of the shelves 20. As illustrated in FIG. 4, an end portion of each of the shelves 20 is connected to the back plate 221. Then, the display panel 30 is attached to an end portion of each of the shelves 20 opposite to the back plate 221. A display surface 301 of the display panel 30 faces opposite to the back plate 221 side.

When viewed from the display surface 301 side, the display panel 30 has, for example, a rectangular shape. A length w₁ of a long side of the display panel 30 is, for example, twice or more than, preferably, five times or more than a length w₂ of a short side of the display panel 30. In the example of the present Figure, the display panel 30 is attached to the shelf 20 in such a way that a long side direction of the display panel 30 is parallel to a product arrangement surface 201 of the shelf 20. One display panel 30 is preferably placed for one shelf 20. Accordingly, the display region 310 of each product can be more freely provided in a wide range of the shelf 20. When one display panel 30 is placed for one shelf 20, the length w₁ of the long side of the display panel 30 is preferably 0.5 times or more than, more preferably 0.8 times or more than a horizontal width wₛ of the shelf 20 viewed from the front. As one example, the display panel 30 having a length w₁ of about 90 cm (e.g., 85 cm or more and 95 cm or less) is placed for the shelf 20 having a width wₛ=90 cm. However, a plurality of the display panels 30 may be placed for one shelf 20. For example, for the shelf having a width wₛ=90 cm, two display panels 30 having a length w₁ of about 45 cm (e.g., 40 cm or more and 50 cm or less) may be placed in a row, or three display panels 30 having a length w₁ of about 30 cm (e.g., 25 cm or more and 35 cm or less) may be placed in a row.

In the present example embodiment, one display panel 30 functions as a plurality of shelf labels by performing a display in such a way that a plurality of the display regions 310 are provided in the display surface 301. Therefore, the number of the used display panels 30 can be small for the number of kinds of products. Accordingly, placement work of the display panel 30 can be easy. With a small number of the display panels 30, maintenance work of the display panel 30 also becomes easy. The display panel 30 may be driven by a power supply other than a battery, such as a commercial power supply. In this case, trouble of battery exchange can be saved. However, the display panel 30 may be driven by a battery. For example, when the display panel 30 uses electronic paper, ensuring a monthly or more drive time is possible, and frequency of battery exchange can be suppressed.

A plurality of the display fixtures 220 are arranged in a store. Display fixture identification information identifying the display fixture 220 to which the display panel 30 is attached, and shelf identification information identifying the shelf 20 are associated with each of the display panels 30. For example, a plurality of the shelves 20 included in the display fixture 220 are numbered in order from top, and the number can be shelf identification information of each of the shelves 20.

As described above, the control apparatus 40 determines the display region 310 for each piece of price label information in the display panel 30 by use of exhibition data of the shelf 20. The display region 310 can be provided on the display surface 301 of the display panel 30 for each kind of a product, that is, for each product code described later.

Herein, as illustrated in FIG. 2, at a position of the display panel 30 being associated with a position of the product 210 exhibited on the shelf 20 where the display panel 30 is placed, the display region 310 of the product 210 is provided. Then, price label information is displayed in each of the display regions 310. Further, at a width being associated with an exhibition width of the product 210, the display region 310 of the product 210 is provided in the display panel 30. In this way, pieces of price label information of a plurality of the products 210 exhibited on the shelf 20 are displayed on the display panel 30 at easily viewed positions and widths. Note that, herein, an exhibition width of the product 210 and a width of the display region 310 are widths in a direction parallel to the product arrangement surface 201 when viewed from the front of the shelf 20. Further, a position of the product 210 and a position of the display region 310 are positions in a direction parallel to the product arrangement surface 201 when viewed from the front of the shelf 20.

In the example of FIG. 2, a frame that demarcates the display region 310 of each piece of price label information is displayed on the display surface 301. Thus, it becomes easy for a customer viewing the display panel 30 to recognize association between the product 210 exhibited on the shelf 20 and a piece of the price label information.

On the shelf 20, the identical products 210 may be exhibited in a plurality of rows. The number of the rows is called the number of faces of the products 210. For example, a width of the display region 310 in the display panel 30 is determined based on the number of faces of the products 210. Specifically, a width of the display region 310 is determined based on a product of a width of the product 210 and the number of faces. In the example of FIG. 2, a display region 310a is the display region 310 of a product whose number of faces is 1, and a display region 310b is the display region 310 of a product 210a whose number of faces is 2.

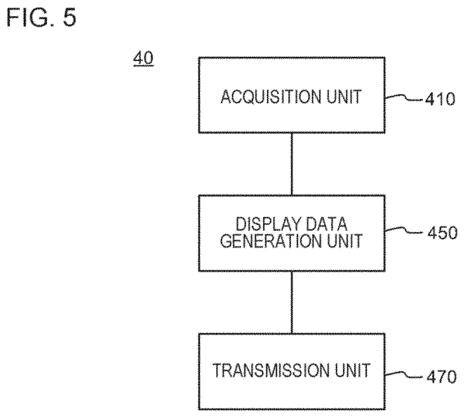

FIG. 5 is a diagram illustrating a configuration of the control apparatus 40 according to the first example embodiment. The control apparatus 40 includes an acquisition unit 410, a display data generation unit 450, and a transmission unit 470. The acquisition unit 410 acquires exhibition data and product information. The display data generation unit 450 generates display data for one or more of the display panels 30, based on the exhibition data and the product information. Then, the transmission unit 470 transmits the display data to each of the display panels 30. The control apparatus 40 can control display contents of a plurality of the display panels 30. Each functional configuration unit is described in detail below.

The acquisition unit 410 acquires exhibition data of the shelf 20 and product information. The acquisition unit 410 can acquire the data and information from outside the control apparatus 40. However, the acquisition unit 410 may acquire exhibition data and product information prepared in advance, by reading the data and information from a storage unit (e.g., a storage device 1080 described later) provided inside or outside the control apparatus 40. The exhibition data indicate arrangement of a product on at least one shelf 20. The exhibition data may be configured for each of the display fixtures 220. The product information includes information indicating a product name and a price of at least a product arranged on the shelf 20. A product code is determined for each product. Products of the same product code are arranged in the same row on the shelf 20. The exhibition data and the product information each includes a product code, and association of a product is possible between the exhibition data and the product information.

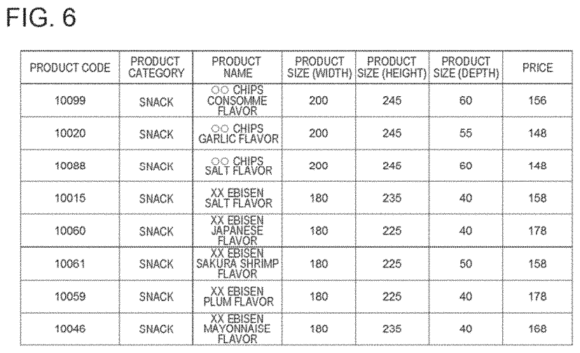

FIG. 6 is a diagram illustrating a configuration of product information according to the first example embodiment. In the present example embodiment, the product information includes a product code, a product category, a product name, a product size, and a price for each of a plurality of products. The product size includes a width, a height, and a depth of a product. Note that, in the present example embodiment, the product information may not include at least one of a product category, a height of a product, and a depth of a product.

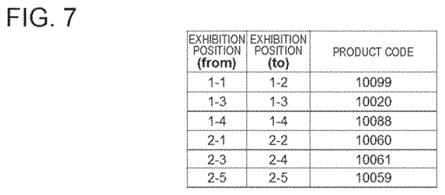

FIG. 7 is a diagram illustrating a configuration of exhibition data according to the first example embodiment. In the present example embodiment, the exhibition data include information indicating an exhibition position, and a product code, for each of a plurality of products. In the example of the present Figure, the information indicating an exhibition position includes an exhibition start position (an “exhibition position (from)” in the present Figure) and an exhibition end position (an “exhibition position (to)” in the present Figure). The exhibition start position and the exhibition end position are each represented by shelf identification information and a row number. In the example of the present Figure, specifically, each position is represented in a form of “shelf identification information—row number”. For example, a number when numbering in order from a left end of a shelf can be determined to be a row number. The exhibition data in the present Figure include information about exhibition on the shelf 20 with shelf identification information being “1” and the shelf 20 with shelf identification information being “2”. In the example of the present Figure, “1-1” means a leftmost row at an uppermost stage. Further, in the example of the present Figure, it is seen that the number of faces of a product with an exhibition start position being “1-1” and an exhibition end position being “1-2” is 2. On the other hand, the number of faces of a product with an exhibition start position and an exhibition end position being the same is 1. In other words, a relation of “number of faces”=“row number of exhibition end position”−“row number of exhibition start position”+1 is satisfied. Display fixture identification information is associated with each piece of the exhibition data.

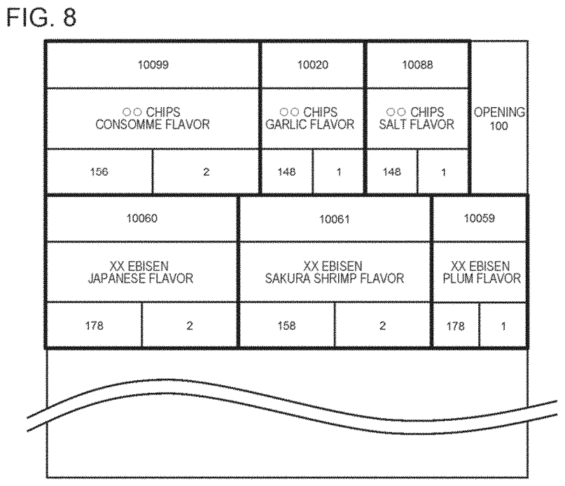

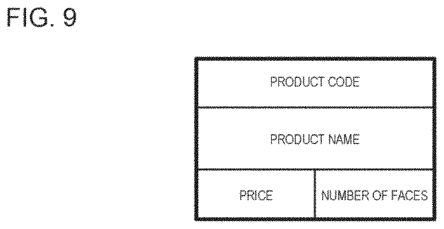

FIG. 8 is a diagram illustrating arrangement of a product based on the product information in FIG. 6 and the exhibition data in FIG. 7. In FIG. 8, information about each product is enclosed by a heavy line. FIG. 9 is a diagram illustrating an explanatory note of a display of each product in FIG. 8. Note that, the explanatory note in FIG. 9 is also applied to each Figure below indicating arrangement of a product. An exhibition width and position of a product are reflected in a width and a position of a display region of each product in FIG. 8, respectively. In the present example, a product is brought close to the left side on each shelf 20, and a remaining space serves as an opening at a right end of the shelf 20. However, a way of taking an opening is not limited to the present example. For example, a left end may serve as an opening, or openings may be provided at both left and right ends in such a way that a product is close to the center. Further, an opening may be arranged between products. FIG. 8 illustrates the arrangement of a product on the shelf 20 (upper stage) with shelf identification information being “1” and the shelf 20 (lower stage) with shelf identification information being “2”.

The display data generation unit 450 determines a position and a width of the display region 310 in the display panel 30, based on product information and exhibition data. Specifically, the display data generation unit 450 derives the number of faces of a product as described above. Further, the display data generation unit 450 refers to a product code, and extracts a width of the product from the product information. The display data generation unit 450 computes a product of the number of faces and the width of the product. Then, the display data generation unit 450 determines, based on the product, a width of the display region 310 of the product. Herein, the computed product may be determined to be a width of the display region 310 as it is, or the computed product being further multiplied by or added to an adjustment parameter may be determined to be a width of the display region 310. In this way, a width of the display region 310 of each product is determined.

In addition, the display data generation unit 450 determines the display panel 30 displaying price label information of each product, based on shelf identification information of exhibition data. Further, the display data generation unit 450 determines an order of displaying price label information of a plurality of products in each of the display panels 30, based on a row number of exhibition data. Then, the display data generation unit 450 generates display data in such a way as to provide a plurality of the display regions 310 in each of the display panels 30 with the determined order and width. Price label information displayed in the display region 310 includes, for example, a product name and a price based on product information. Display fixture identification information and shelf identification information are related to each piece of display data.

The transmission unit 470 transmits the generated display data to the display panel 30. Each piece of display data is received by the display panel 30 to be displayed the display data, based on the display fixture identification information and the shelf identification information being related to the display data. A display content based on the received display data is displayed on the display panel 30.

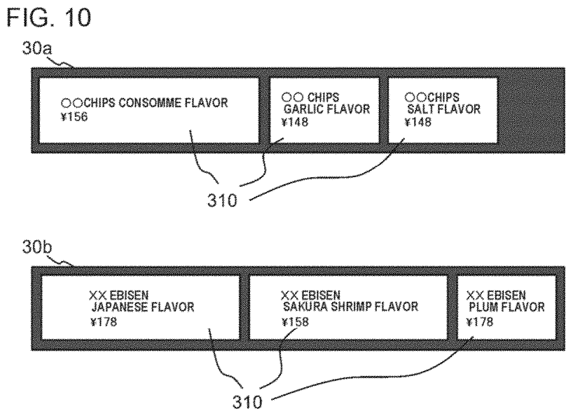

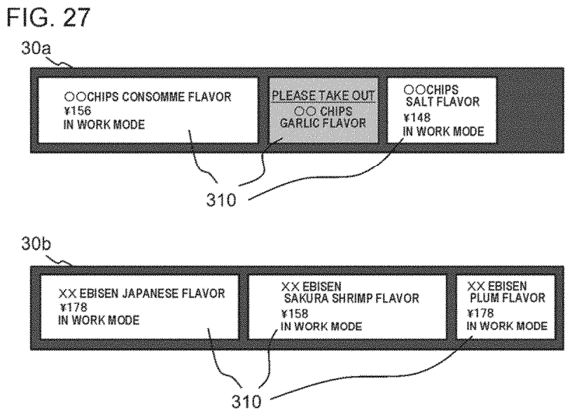

FIG. 10 is a diagram illustrating the display panel 30 on which price label information is displayed based on the product information in FIG. 6 and the exhibition data in FIG. 7. In the present Figure, a display panel 30a illustrates the display panel 30 placed on the shelf 20 (with shelf identification information being “1”) at an uppermost stage, and a display panel 30b illustrates the display panel 30 placed on the shelf 20 (with shelf identification information being “2”) at a second highest stage in the same display fixture 220. Price label information of a product exhibited at an associated position of the shelf 20, specifically, immediately above each of the display regions 310 is displayed in each of the display regions 310. A comment such as “at discount”, “new product”, or “recommended” may be further displayed in the display region 310. Further, a picture of a product, an explanation, and the like may be displayed in the display region 310. Although FIG. 10 illustrates an example in which the display region 310 is brought close to left in the display panel 30a, the display region 310 may be centered in the display panel 30. The same also applies to FIGS. 27, 29 to 35, 38, and 40 described later.

In this way, the display region 310 is determined based on exhibition data and product information, and price label information is displayed. Therefore, replacement work of a price label does not need to be done for each exhibition change and price change. In other words, labor of a clerk can be lessened, and an attachment mistake or a description mistake of a price label can be eliminated. Further, the display region 310 can be freely provided over the display surface 301 of the display panel 30. Therefore, as compared with a case where price label information is displayed on a plurality of displays, a degree of freedom in exhibition of a product increases, and appearance also becomes better.

Note that, a clerk can do work by reference to price label information displayed on the display panel 30 when a product is exhibited on the shelf 20 on which nothing is arranged. Accordingly, a product can be efficiently and correctly exhibited regardless of a skill level of a clerk.

A hardware configuration of the control apparatus 40 is described below. Each functional configuration unit of the control apparatus 40 may be achieved by hardware (example: a hard-wired electronic circuit, or the like) that achieves each functional configuration unit, or may be achieved by a combination of hardware and software (example: a combination of an electronic circuit and a program controlling the electronic circuit, or the like). A case where each functional configuration unit of the control apparatus 40 is achieved by a combination of hardware and software is further described below.

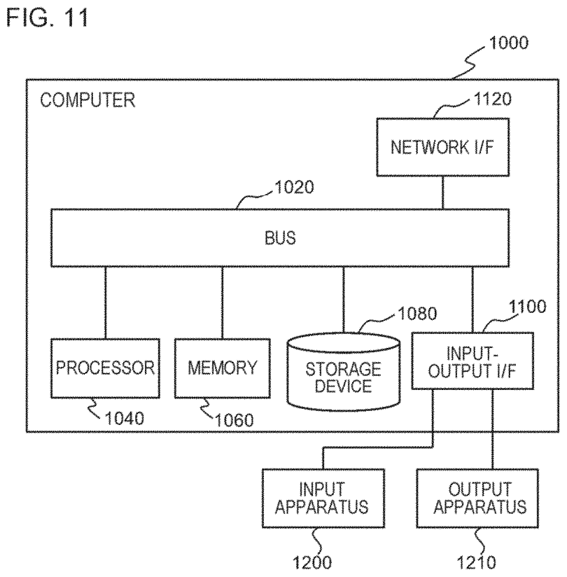

FIG. 11 is a diagram illustrating a computer 1000 for achieving the control apparatus 40. The computer 1000 is any computer. For example, the computer 1000 is a system on chip (SoC), a personal computer (PC), a server machine, a tablet terminal, a smartphone, or the like. The computer 1000 may be a dedicated computer designed in order to achieve the control apparatus 40, or may be a general-purpose computer.

The computer 1000 includes a bus 1020, a processor 1040, a memory 1060, the storage device 1080, an input-output interface 1100, and a network interface 1120. The bus 1020 is a data transmission path for the processor 1040, the memory 1060, the storage device 1080, the input-output interface 1100, and the network interface 1120 to mutually transmit and receive data. However, a way of connecting the processor 1040 and the like to one another is not limited to bus connection. The processor 1040 is a variety of processors such as a central processing unit (CPU), a graphics processing unit (GPU), or a field-programmable gate array (FPGA). The memory 1060 is a main storage apparatus achieved by use of a random access memory (RAM) and the like. The storage device 1080 is an auxiliary storage apparatus achieved by use of a hard disk, a solid state drive (SSD), a memory card, a read only memory (ROM), and the like.

The input-output interface 1100 is an interface for connecting the computer 1000 and an input-output device. For example, an input apparatus 1200 such as a mouse or a keyboard, and an output apparatus 1210 such as a display apparatus are connected to the input-output interface 1100.

The network interface 1120 is an interface for connecting the computer 1000 to a network. The communication network is, for example, a local area network (LAN) or a wide area network (WAN). A way in which the network interface 1120 is connected to a network may be wireless connection, or may be wired connection.

The storage device 1080 stores a program module that achieves each functional configuration unit of the control apparatus 40. The processor 1040 achieves a function being associated with each program module, by reading each of the program modules into the memory 1060 and executing the program module.

In the present example embodiment, the display panel 30 is connected to the computer 1000 via the input-output interface 1100 or the network interface 1120.

Next, an advantage and an effect according to the present example embodiment are described. The system 10 and the control apparatus 40 according to the present example embodiment determine the display region 310 of information relating to each product in the display panel 30, based on exhibition data. Therefore, replacement or movement of a shelf label does not need to be done, and trouble during an exhibition change of a product can be reduced. Further, since an extent of the display region 310 can be changed according to the number of faces, information relating to a product can be more strongly appealed to a customer.

### Second Example Embodiment

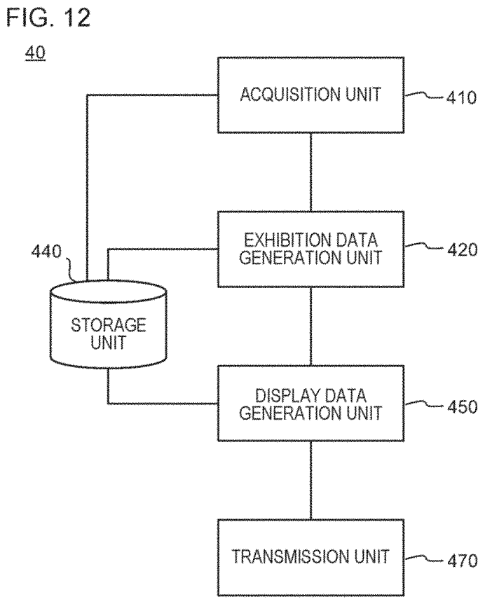

FIG. 12 is a diagram illustrating a configuration of a control apparatus 40 according to a second example embodiment. A system 10 and the control apparatus 40 according to the present example embodiment are the same as the system 10 and the control apparatus 40 according to the first example embodiment, respectively, except that the control apparatus 40 includes an exhibition data generation unit 420. Description is given in detail below.

The control apparatus 40 according to the present example embodiment is achievable by a computer 1000 as illustrated in FIG. 11. A storage device 1080 of the computer 1000 further stores a program module that achieves the exhibition data generation unit 420. A processor 1040 further achieves a function of the exhibition data generation unit 420 by reading the program module into a memory 1060 and executing the program module.

The exhibition data generation unit 420 generates exhibition data. As examples of ways in which the exhibition data generation unit 420 generates exhibition data, first to third processing examples below are cited. The first processing example is a way in which a user manually determines arrangement of a product from product information. The second processing example is a way in which exhibition data are generated based on arrangement of an exhibited product. The third processing example is a way in which basic exhibition data are changed into new exhibition data. Note that, a user is, for example, a clerk of a store.

In the first processing example, a product list as illustrated in FIG. 6 is displayed on a display connected to the computer 1000 as an output apparatus 1210. Further, an image diagram of exhibition to a display fixture 220 as illustrated in FIG. 8 is displayed on a display. Then, a user of the control apparatus 40 uses an input apparatus 1200 connected to the computer 1000, and selects, from the product list, a product which the user desires to register in exhibition data. Further, the user registers the product in the exhibition data by specifying, in the image diagram of exhibition, a position to arrange the selected product. In this instance, the user can further set the number of faces of the product. When finishing registration of all products which the user desires to exhibit, the user performs a determination operation. Accordingly, exhibition data are generated based on an exhibition content in the image diagram displayed on the display.

In the present example, an acquisition unit 410 acquires product information as in the first example embodiment. The acquisition unit 410 accepts each of the inputs described above from a user by the input apparatus 1200. Then, the exhibition data generation unit 420 generates exhibition data, based on an input content and the product information.

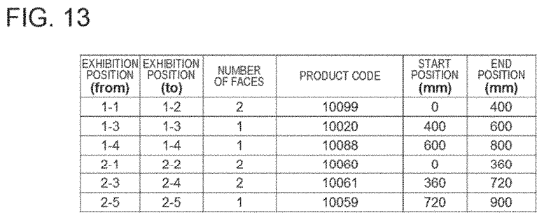

FIG. 13 is a diagram illustrating a configuration of exhibition data generated in the first processing example. In the example of the present Figure, exhibition data include, for each of a plurality of products, information indicating an exhibition position, a product code, the number of faces, a start position, and an end position. The exhibition data generation unit 420 can generate such exhibition data, based on a product code, an exhibition position, and the number of faces based on an input content from a user, and a width of a product extracted from product information by use of the product code.

In the second processing example, a reading unit for a bar code and the like is connected to the computer 1000 as the input apparatus 1200. A product is exhibited on a shelf 20 in advance. A user reads, for example, a bar code of a product on each shelf 20 from left in order. Herein, a product arrayed with two faces is read twice. The user does similar work for a plurality of the shelves 20 in order.

In the present example, the acquisition unit 410 acquires product information as in the first example embodiment. Further, the acquisition unit 410 acquires a reading result of a bar code from the input apparatus 1200. The reading result includes information indicating a product code. The exhibition data generation unit 420 searches for the product code indicated in the reading result from the product information, and acquires a product name, a price, and a width of the product. Then, the exhibition data generation unit 420 generates exhibition data, based on the acquired product name, price, and width of the product, and the number of faces based on the reading result of the bar code. In the present example as well, exhibition data as in FIG. 13 can be generated, as in the first processing example.

In the third processing example, an image diagram of exhibition to the display fixture 220 as in FIG. 8 is displayed on, for example, a display connected to the computer 1000 as the output apparatus 1210. Then, a user produces new exhibition data by using the input apparatus 1200, and performing an operation, to the displayed image diagram, such as reduction of a face (i.e., decreasing the number of faces), enlargement of a face (i.e., increasing the number of faces), deletion of a product, and insertion of a product.

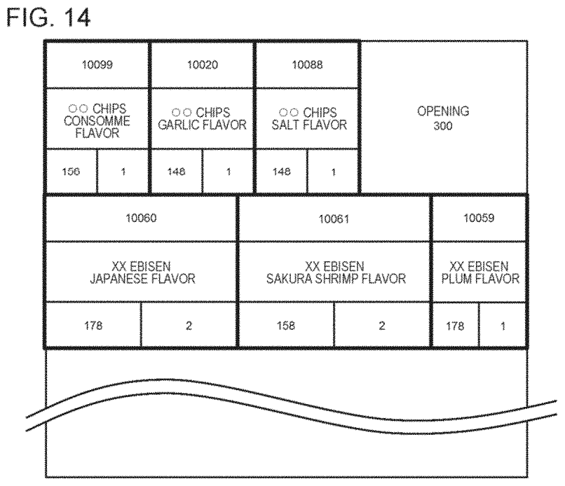

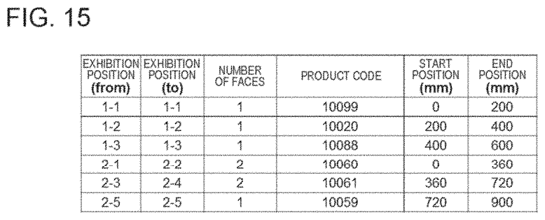

FIG. 14 is a diagram illustrating an operation screen when a face is reduced. FIG. 15 is a diagram illustrating a configuration of exhibition data being associated with product arrangement in FIG. 14. In the present example, for example, an image diagram of basic exhibition data as in FIG. 8 is first displayed on a display connected to the computer 1000 as the output apparatus 1210. Then, a user uses the input apparatus 1200 connected to the computer 1000, selects, on a screen, a product which the user desires to reduce a face, and performs an operation of reducing the face. FIG. 14 illustrates a state where the number of faces for “∘∘ chips consomme flavor” is changed from 2 to 1, in contrast to the example in FIG. 8.

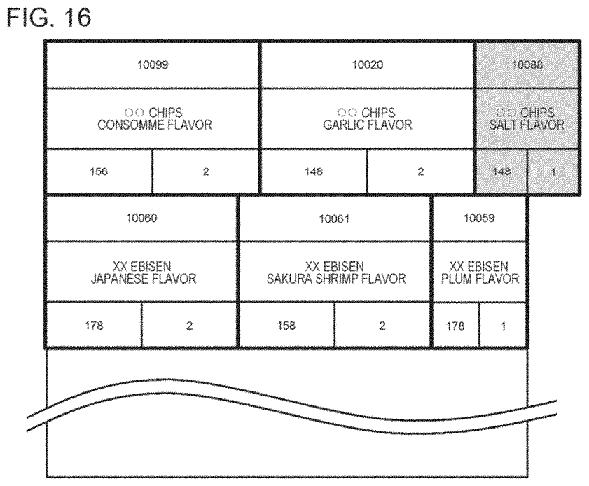

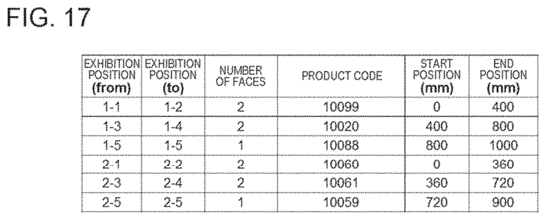

FIG. 16 is a diagram illustrating an operation screen when a face is enlarged. FIG. 17 is a diagram illustrating a configuration of exhibition data being associated with product arrangement in FIG. 16. In the present example, for example, an image diagram of basic exhibition data as in FIG. 8 is first displayed on a display connected to the computer 1000 as the output apparatus 1210. Then, a user uses the input apparatus 1200 connected to the computer 1000, selects, on a screen, a product which the user desires to enlarge a face, and performs an operation of enlarging the face. FIG. 16 illustrates a state where the number of faces for “∘∘ chips garlic flavor” is changed from 1 to 2, in contrast to the example in FIG. 8.

However, in this case, a product at a right end of the upper-stage shelf 20 is not contained in the display fixture 220 due to enlargement of the face. Thus, the exhibition data generation unit 420 may caution a user by altering a display color of the product that is not contained in the shelf 20, and the like. A user viewing such a caution display can further change a position of a product and the number of faces. Specifically, size information of the shelf 20 is saved in advance in a storage unit 440 being accessible from the exhibition data generation unit 420. Note that, the storage unit 440 may be included in the control apparatus 40, or may be provided outside the control apparatus 40. The exhibition data generation unit 420 reads the size information from the storage unit 440, and determines whether the product is contained in the shelf 20 as an input content of a user. In other words, the exhibition data generation unit 420 determines whether a sum of widths of all products registered for exhibition on the shelf 20 is equal to or less than a width of the shelf 20. Then, when determining that the product is not contained in the shelf 20, the exhibition data generation unit 420 changes a display in such a way that the product in problem becomes discriminable from another product on a display. Note that, determination based on the size information of the shelf 20 is not limited to a width. For example, size information may include a height of a thing being exhibitable on the shelf 20, and determination based on the size information may include determination of whether a height of a product is equal to or less than a height of a thing being exhibitable on the shelf 20.

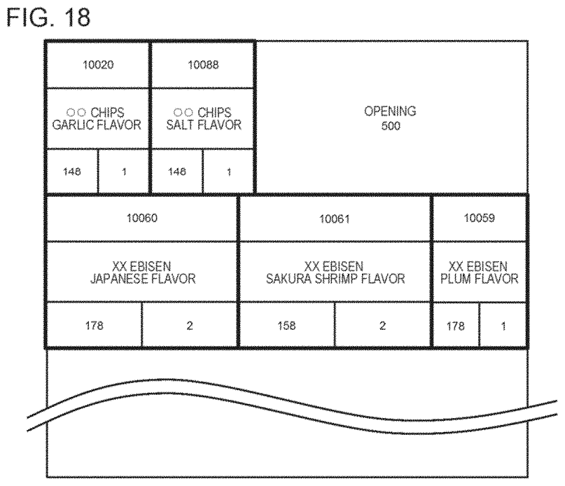

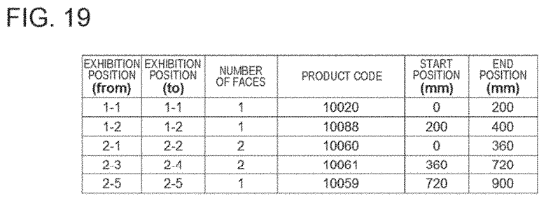

FIG. 18 is a diagram illustrating an operation screen when a product is deleted. FIG. 19 is a diagram illustrating a configuration of exhibition data being associated with product arrangement in FIG. 18. In the present example, for example, a schematic diagram of basic exhibition data as in FIG. 8 is first displayed on a display connected to the computer 1000 as the output apparatus 1210. Then, a user uses the input apparatus 1200 connected to the computer 1000, selects, on a screen, a product which the user desires to delete from the exhibition data, and performs an operation of deletion. FIG. 18 illustrates a state where deletion of “∘∘ chips consomme flavor” is performed, in contrast to the example in FIG. 8.

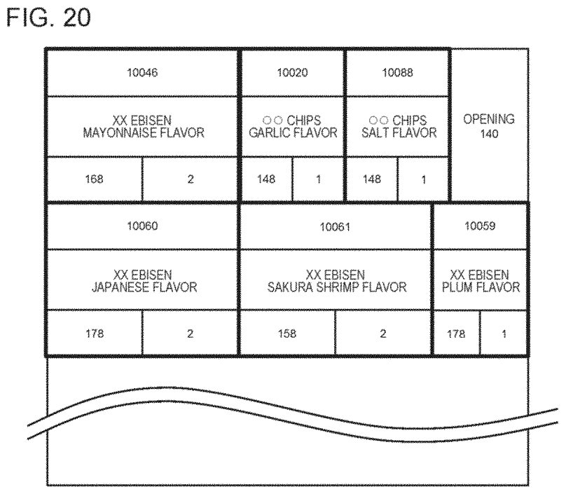

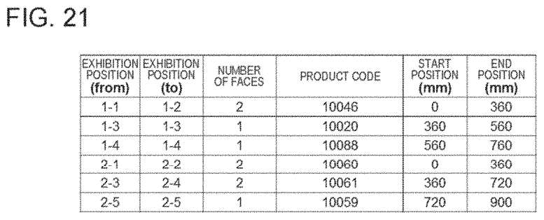

FIG. 20 is a diagram illustrating an operation screen when a product is inserted. FIG. 21 is a diagram illustrating a configuration of exhibition data being associated with product arrangement in FIG. 20. In the present example, for example, a schematic diagram of basic exhibition data as in FIG. 18 is displayed on a display connected to the computer 1000 as the output apparatus 1210. A list of products being addable based on product information is further displayed on the display. Then, a user uses the input apparatus 1200 connected to the computer 1000, selects, on a screen, a product which the user desires to add to exhibition data, and performs an operation of insertion. FIG. 20 illustrates a state where “xx ebisen mayonnaise flavor” (“xx shrimp rice cracker mayonnaise flavor”) is added, in contrast to the example in FIG. 18.

A user performing a change of exhibition by operations such as reduction of a face, enlargement of a face, deletion of a product, and insertion of a product as described above further performs a determination operation of exhibition. Accordingly, exhibition data indicating an exhibition state displayed on a display are generated.

A display data generation unit 450 according to the present example embodiment can generate display data for the display panel 30 and display the display data on the display panel as in the first example embodiment, by use of exhibition data generated by the exhibition data generation unit 420. Further, the exhibition data generated in the exhibition data generation unit 420 may be temporarily saved in the storage unit 440.

The display data generation unit 450 can change the display region 310 and price label information, based on exhibition data. For example, when exhibition data are newly generated in the exhibition data generation unit 420 in a state where price label information is already displayed based on display data, the display data generation unit 450 generates new display data based on the exhibition data. Then, a transmission unit 470 transmits the new display data to the display panel 30, based on a display switch operation of a user. As a result, a display based on the new display data is performed on the display panel 30.

Next, an advantage and an effect according to the present example embodiment are described. In the present example embodiment, an advantage and an effect similar to those according to the first example embodiment can be acquired. In addition, exhibition data can be easily produced and changed in the control apparatus 40.

### Third Example Embodiment

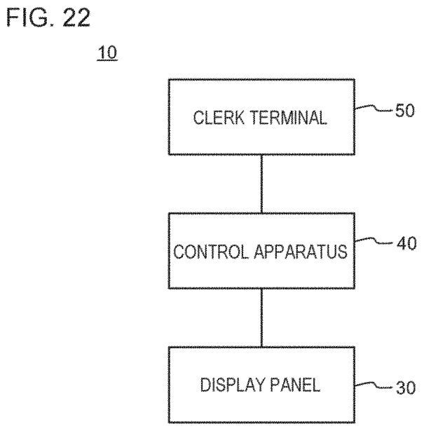

FIG. 22 is a diagram illustrating a configuration of a system 10 according to a third example embodiment. The system 10 according to the present example embodiment is the same as the system 10 according to at least either one of the first and second example embodiments, except for a point described below. Further, a control apparatus 40 according to the present example embodiment is the same as the control apparatus 40 according to at least either one of the first and second example embodiments, except for a point described below.

In the present example embodiment, the control apparatus 40 switchingly displays a display content for a clerk and a display content for a customer on a display panel 30. A display content for a customer includes one or more pieces of price label information. A display content for a customer is as described in the first and second example embodiments, and can be illustrated as an example in FIG. 2 or 10.

In the present example embodiment, the control apparatus 40 changes a display content on the display panel 30 from a display content for a clerk to a display content for a customer, or from a display content for a customer to a display content for a clerk. A display content on the display panel 30 varies based on control of the control apparatus 40. Herein, a display content for a clerk and a display content for a customer may at least partly have a common content. Specifically, the control apparatus 40 may change a part of a display content on the display panel 30. In other words, the control apparatus 40 may shift at least part of a display content on the display panel 30 from a display content for a clerk to a display content for a customer, or from a display content for a customer to a display content for a clerk. Further, the control apparatus 40 may switch part of a display region 310 of the display panel 30 from a display content for a clerk to a display content for a customer, or from a display content for a customer to a display content for a clerk. In addition, the control apparatus 40 may switch a display content on the display panel 30 to yet another content such as an out-of-service mode.

As illustrated in FIG. 22, the system 10 according to the third example embodiment further includes a clerk terminal 50. Then, the control apparatus 40 switches between a display content for a clerk and a display content for a customer, based on input to the clerk terminal 50. Similarly to the control apparatus 40, hardware that achieves the clerk terminal 50 is illustrated by a computer 1000 as in FIG. 11. However, the computer 1000 that achieves the clerk terminal 50 may be provided separately from the computer 1000 that achieves the control apparatus 40. The clerk terminal 50 is, for example, a mobile terminal such as a smartphone. The mobile terminal includes, for example, a touch panel doubling as an input apparatus 1200 and a display as an output apparatus 1210. The clerk terminal 50 and the control apparatus 40 are communicable with each other via, for example, at least either one of a network interface 1120 and an input-output interface 1100.

A display content for a clerk includes information for supporting work of a clerk. In the present example embodiment, a display content for a clerk includes change information indicating a change in arrangement of a product on a shelf 20. The change information is, for example, information indicating work to be done by a clerk for an exhibition change of a product. Further, the control apparatus 40 switches change information, based on switch information indicating that a work content of a clerk is switched. Work to be done is sequentially indicated to a clerk by switching of change information. Then, a clerk can efficiently advance the exhibition change irrespective of a proficiency level by sequentially doing work in accordance with the change information.

In the present example embodiment, switch information is information based on input to the clerk terminal 50. Specifically, when completing work displayed on the display panel 30, a clerk performs, on the clerk terminal 50, an operation indicating the completion. Accordingly, information indicating that the work completion operation is performed is transmitted to the control apparatus 40 from the clerk terminal 50. Then, the control apparatus 40 switches a display content on the display panel 30 to next change information. The clerk performs next work in accordance with the new change information displayed on the display panel 30.

The control apparatus 40 generates display data indicating a display content for a clerk, based on first exhibition data before a change in arrangement of a product, and second exhibition data after the change in arrangement of a product. Specifically, the display data include change information indicating work to be done in order to achieve arrangement after the change from arrangement before the change. A display data generation unit 450 of the control apparatus 40 generates a plurality of pieces of display data sequentially including change information indicating work to be done. Then, a transmission unit 470 sequentially transmits the pieces of display data to the display panel 30, based on the switch information.

Processing performed in the system 10 and a use method of the system 10 are described in detail below.

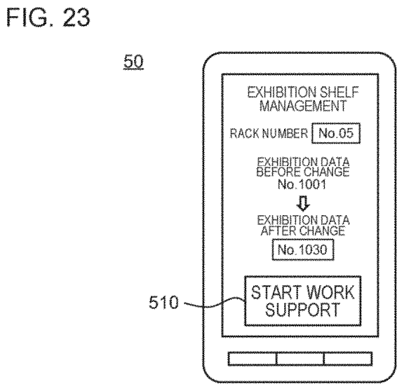

FIG. 23 is a diagram illustrating a display screen of the clerk terminal 50 for switching a display content on the display panel 30. It is assumed that a display content for a customer is displayed on the display panel 30 before switch. A clerk intending to perform an exhibition change first specifies a display fixture 220 in which the clerk intends to perform an arrangement change in the clerk terminal 50. The clerk specifies exhibition data after change. Then, the clerk performs an operation for starting work. In the example of the present Figure, specifically, the clerk taps a start button 510 after selecting or inputting a rack number and exhibition data after change. Note that, specification of the display fixture 220 may be performed by reading a code affixed to the display fixture 220 with a camera of the clerk terminal 50.

When the operation for starting work is performed on the clerk terminal 50, the display data generation unit 450 acquires, as the first exhibition data, current exhibition data of the display fixture 220 specified by the clerk terminal 50. The display data generation unit 450 acquires, as the second exhibition data, exhibition data after change specified by the clerk terminal 50.

In the present example embodiment, a configuration of the control apparatus 40 can be illustrated by FIG. 5 or 12. In the present example embodiment, the first exhibition data and the second exhibition data are acquired by an acquisition unit 410 as described in the first example embodiment. Alternatively, the first exhibition data and the second exhibition data are generated by an exhibition data generation unit 420 as described in the second example embodiment. Further, either the first exhibition data or the second exhibition data may be acquired by the acquisition unit 410, and the other may be generated by the exhibition data generation unit 420. The display data generation unit 450 may acquire each piece of exhibition data from the acquisition unit 410, may acquire each piece of exhibition data from the exhibition data generation unit 420, or may read and acquire each piece of exhibition data from a storage unit 440.

Furthermore, the display data generation unit 450 extracts a difference between the first exhibition data and the second exhibition data as below, and generates change information, based on the difference.

The exhibition change is, for example, constituted of “work of making a space”, “work of moving a product”, and “work of introducing a product”. The “work of making a space” is at least either one of work of taking out a product from a shelf and work of reducing a face. The “work of moving a product” is at least either one of work of moving a product in the same shelf 20 and work of moving a product to the different shelf 20. The “work of introducing a product” is at least either one of work of enlarging a face and work of adding a new product. The display data generation unit 450 displays the change information on the display panel 30 in such a way that at least one of the “work of making a space”, the “work of moving a product”, and the “work of introducing a product” is carried out. Herein, the “work of making a space”, the “work of moving a product”, and the “work of introducing a product” are preferably carried out in this order. Each work is performed for each row of products.

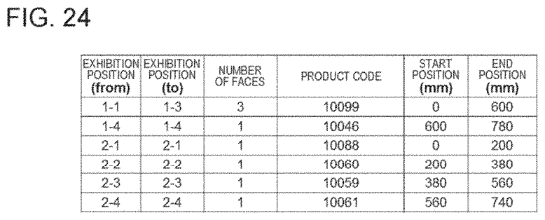

FIG. 24 is a diagram illustrating a configuration of the second exhibition data. FIG. is a diagram illustrating arrangement of a product based on the exhibition data in FIG. 24. It is assumed that the first exhibition data are illustrated by FIG. 13. Arrangement of a product illustrated by FIG. 13 is schematically represented by FIG. 8. A display content for a customer based on the first exhibition data is illustrated by FIG. 10. Exhibition support is described in detail below with reference to examples of the first exhibition data and the second exhibition data. However, the first exhibition data and the second exhibition data are not limited to the present example.

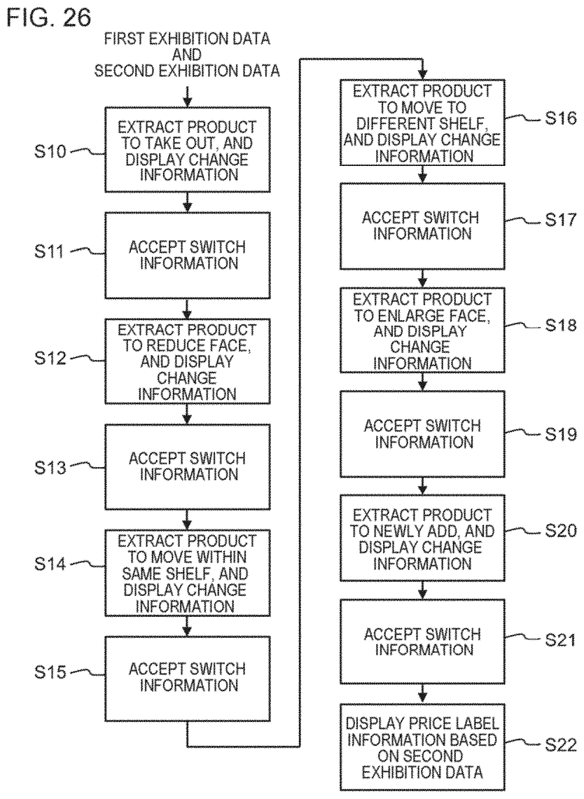

FIG. 26 is a flowchart illustrating processing performed by the display data generation unit 450 in order to display a display content for a clerk on the display panel 30. The display data generation unit 450 performs step S10 when the first exhibition data and the second exhibition data are acquired. In step S10, the display data generation unit 450 extracts, from the first exhibition data, a product to be taken out. In other words, the display data generation unit 450 extracts, as a product to be taken out, a product that is included in the first exhibition data and is not included in the second exhibition data. Then, the display data generation unit 450 generates display data that display, on the display panel 30, change information indicating taking out the extracted product. The generated display data are transmitted to the display panel 30, and the change information is displayed on the display panel 30. Note that, when no product to be taken out is present, the display data generation unit 450 performs step S12 without generating display data.

FIG. 27 is a diagram illustrating the display panel 30 on which change information indicating taking out a product is displayed. A product with a product code “10020” is extracted from the first exhibition data in FIG. 13 in step S10. Then, a display encouraging takeout is performed in the display region 310 of the product being associated with the product code. A clerk viewing this takes out the product in response to the display. Note that, price label information may be displayed in the display region 310 of the product that is not a work target. Accordingly, a customer can check a price of the product even when a clerk is at work. A display such as “in a work mode” indicating that a display content is a display content for a clerk may be further performed in the display region 310.

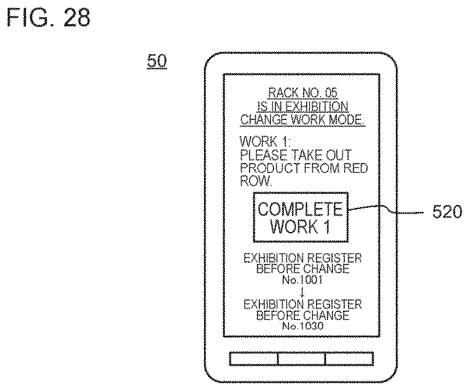

FIG. 28 is a display screen of the clerk terminal 50 for transmitting switch information to the control apparatus 40. During work, a display as in the present Figure is performed on the clerk terminal 50. Then, when work displayed on the display panel 30 is finished, a clerk performs, on the clerk terminal 50, input indicating that the work is finished. Specifically, a clerk taps a completion button 520. Accordingly, switch information based on the input to the clerk terminal 50 is transmitted from the clerk terminal 50 to the control apparatus 40. When the control apparatus 40 receives the switch information, the display data generation unit 450 accepts the received switch information (step S11), and then performs processing in step S12. Note that, when there are a plurality of products extracted in step S10, the display data generation unit 450 accepting the switch information generates display data for displaying change information indicating taking out a next product. Then, processing transfers to step S12 at a point where change information regarding all products extracted in step S10 is displayed, and switch information is accepted.

In step S12, the display data generation unit 450 extracts, from the first exhibition data, a product whose face is to be reduced. In other words, the display data generation unit 450 compares the number of faces of a product other than a product extracted in step S10 from a product included in the first exhibition data, with the number of faces of a product included in the second exhibition data. The display data generation unit 450 extracts, as a product whose face is to be reduced, a product whose number of faces in the second exhibition data is smaller than the number of faces in the first exhibition data. Then, the display data generation unit 450 generates display data that display, on the display panel 30, change information indicating reducing a face of the extracted product. The generated display data are transmitted to the display panel 30, and the change information is displayed on the display panel 30. Note that, when no product whose face is to be reduced is present, the display data generation unit 450 performs step S14 without generating display data.

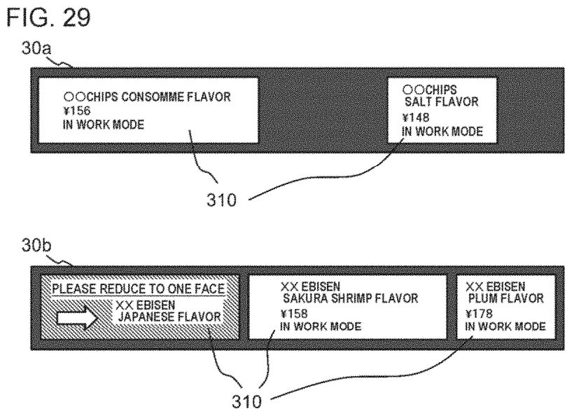

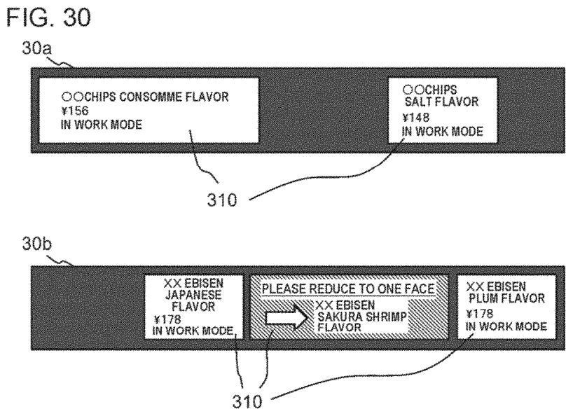

FIGS. 29 and 30 are diagrams illustrating the display panel 30 on which change information indicating reducing a face of a product is displayed. From the first exhibition data in FIG. 13, products with product codes “10060” and “10061” are extracted in step S12. First, a display encouraging reduction of a face is performed in the display region 310 of a product being associated with either one of the product codes as in FIG. 29. The display may include the number of faces after change. Herein, the display data generation unit 450 may compare the first exhibition data with the second exhibition data, and display a direction of reducing a face with an arrow or the like. Although change information is displayed in the display region 310 before reduction of a face in the example of the present Figure, change information may be displayed only in the display region 310 after reduction of a face. Thus, it becomes easy for a clerk to recognize which region a face may be reduced toward. Further, progress of work may be reflected in displays on a display panel 30a and a display panel 30b in each step. In the example of the present Figure, for example, the display region 310 is not displayed in a part becoming a space due to takeout of a product in previous work.

A clerk viewing the display panel 30 reduces a face of a product in response to the display. Then, when work displayed on the display panel 30 is finished, the clerk performs, on the clerk terminal 50, input indicating that the work is finished, as in step S11. Accordingly, a display encouraging reduction of a face is performed in the display region 310 of a product being associated with another product code as in FIG. 30. In this way, when change information of all extracted products is displayed, and switch information based on input to the clerk terminal 50 is transmitted to the control apparatus 40 from the clerk terminal 50 (step S13), the display data generation unit 450 then performs step S14.

In step S14, the display data generation unit 450 extracts, from the first exhibition data, a product to be moved within the same shelf 20. In other words, the display data generation unit 450 compares shelf identification information of a product other than a product extracted in step S10 from a product included in the first exhibition data, with shelf identification information of a product included in the second exhibition data. Then, the display data generation unit 450 extracts a product whose shelf identification information coincides between pieces of the exhibition data. Further, the display data generation unit 450 compares a position of the extracted product between the first exhibition data and the second exhibition data, and extracts a product needing a change of a position, as a product to be moved within the same shelf 20. The display data generation unit 450 then generates display data that display, on the display panel 30, change information indicating moving the extracted product. The generated display data are transmitted to the display panel 30, and the change information is displayed on the display panel 30. Note that, when no product to be moved within the same shelf 20 is present, the display data generation unit 450 performs step S16 without generating display data.

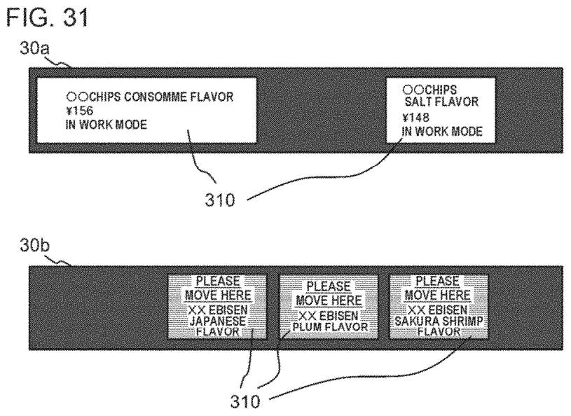

FIG. 31 is a diagram illustrating the display panel 30 on which change information indicating moving a product within the same shelf 20 is displayed. From the first exhibition data in FIG. 13, products with product codes “10060”, “10061”, and “10059” are extracted in step S14. Then, a display encouraging movement is performed in the display region 310 of products being associated with the product codes. A clerk viewing this moves the product in response to the display. In the example of the present Figure, since arrangement of a product after movement is indicated on the display panel 30 as arrangement of the display region 310, work can be done efficiently. Then, when work displayed on the display panel 30 is finished, the clerk performs, on the clerk terminal 50, input indicating that the work is finished, as in step S11. Accordingly, switch information based on the input to the clerk terminal 50 is transmitted from the clerk terminal 50 to the control apparatus 40. When accepting the switch information (step S15), the display data generation unit 450 then performs step S16.

In step S16, the display data generation unit 450 extracts, from the first exhibition data, a product to be moved to the different shelf 20. In other words, the display data generation unit 450 compares shelf identification information of a product other than a product extracted in step S10 from a product included in the first exhibition data, with shelf identification information of a product included in the second exhibition data. Then, the display data generation unit 450 extracts a product whose shelf identification information does not coincide between pieces of the exhibition data, as a product to be moved to the different shelf 20. The display data generation unit 450 then generates display data that display, on the display panel 30, change information indicating moving the extracted product. The generated display data are transmitted to the display panel 30, and the change information is displayed on the display panel 30. Note that, when no product to be moved to the different shelf 20 is present, the display data generation unit 450 performs step S18 without generating display data.

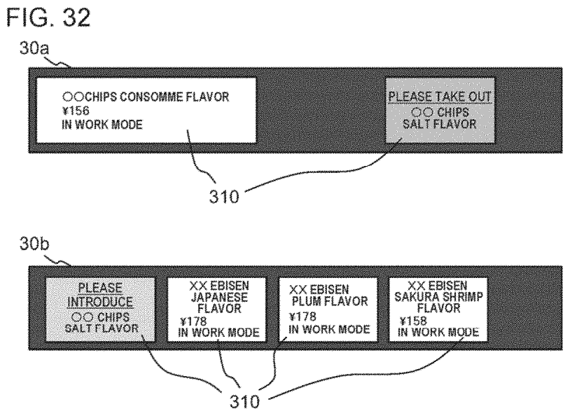

FIG. 32 is a diagram illustrating the display panel 30 on which change information indicating moving a product to the different shelf 20 is displayed. From the first exhibition data in FIG. 13, a product with a product code “10088” is extracted in step S16. Then, a display encouraging movement is performed in the display region 310 of a product being associated with the product code. Specifically, the display is a display encouraging to take out a product from the shelf 20 being a movement source, and a display encouraging to introduce a product to the shelf 20 being a movement destination. In the example of the present Figure, since arrangement of a product after movement is indicated on the display panel 30 as arrangement of the display region 310, work can be done efficiently.

A clerk viewing the display panel 30 moves the product in response to the display. Then, when work displayed on the display panel 30 is finished, the clerk performs, on the clerk terminal 50, input indicating that the work is finished, as in step S11. Accordingly, switch information based on input to the clerk terminal 50 is transmitted from the clerk terminal 50 to the control apparatus 40. When accepting the switch information (step S17), the display data generation unit 450 then performs step S18. Note that, when there are a plurality of products extracted in step S16, the display data generation unit 450 accepting the switch information generates display data for displaying change information indicating moving a next product. Processing transfers to step S18 at a point where change information regarding all products extracted in step S16 is displayed, and switch information is accepted.

In step S18, the display data generation unit 450 extracts, from the first exhibition data, a product whose face is to be enlarged. In other words, the display data generation unit 450 compares the number of faces of a product other than a product extracted in step S10 from a product included in the first exhibition data, with the number of faces of a product included in the second exhibition data. The display data generation unit 450 extracts, as a product whose face is to be enlarged, a product whose number of faces in the second exhibition data is larger than the number of faces in the first exhibition data. Then, the display data generation unit 450 generates display data that display, on the display panel 30, change information indicating enlarging a face of the extracted product. The generated display data are transmitted to the display panel 30, and the change information is displayed on the display panel 30. Note that, when no product whose face is to be enlarged is present, the display data generation unit 450 performs step S20 without generating display data.

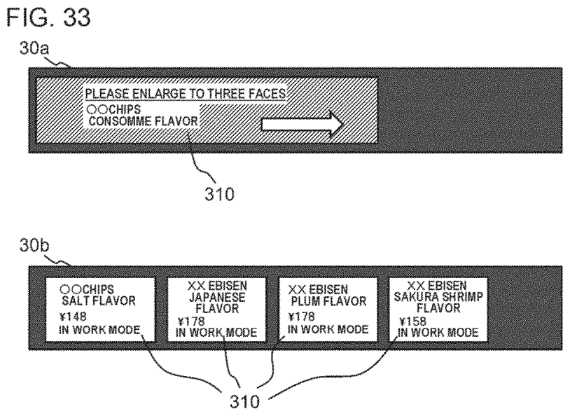

FIG. 33 is a diagram illustrating the display panel 30 on which change information indicating enlarging a face of a product is displayed. From the first exhibition data in FIG. 13, a product with a product code “10099” is extracted in step S18. Then, a display encouraging enlargement of a face is performed in the display region 310 of a product being associated with the product code. The display may include the number of faces after change. Herein, the display data generation unit 450 may compare the first exhibition data with the second exhibition data, and display a direction of enlarging a face with an arrow or the like. In the example of the present Figure, change information is displayed in the display region 310 after enlargement of a face. Thus, it becomes easy for a clerk to recognize how far a face may be enlarged.

A clerk viewing the display panel 30 enlarges a face of a product in response to the display. Then, when work displayed on the display panel 30 is finished, the clerk performs, on the clerk terminal 50, input indicating that the work is finished, as in step S11. Accordingly, switch information based on input to the clerk terminal 50 is transmitted to the control apparatus 40 from the clerk terminal 50. When accepting the switch information (step S19), the display data generation unit 450 then performs step S20. Note that, when there are a plurality of products extracted in step S18, the display data generation unit 450 accepting the switch information generates display data for displaying change information indicating enlarging a face of a next product. Then, processing transfers to step S20 at a point where change information regarding all products extracted in step S18 is displayed, and switch information is accepted.

In step S20, the display data generation unit 450 extracts, from the second exhibition data, a product to be introduced. In other words, the display data generation unit 450 extracts, as a product to be introduced, a product that is included in the second exhibition data and is not included in the first exhibition data. Then, the display data generation unit 450 generates display data that display, on the display panel 30, change information indicating introducing the extracted product. The generated display data are transmitted to the display panel 30, and the change information is displayed on the display panel 30. Note that, when no product to be introduced is present, the display data generation unit 450 performs step S22 without generating display data.

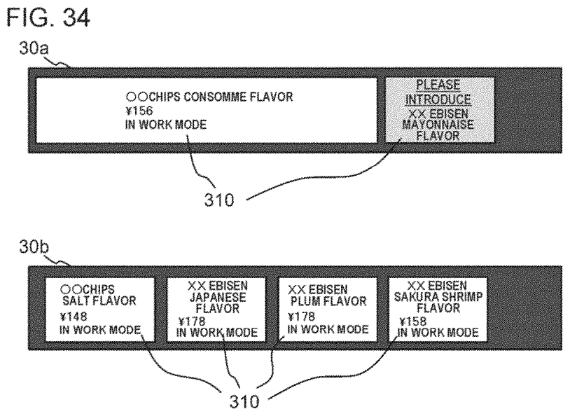

FIG. 34 is a diagram illustrating the display panel 30 on which change information indicating introducing a product is displayed. From the second exhibition data in FIG. 24, a product with a product code “10046” is extracted in step S20. Then, a display encouraging introduction is performed in the display region 310 of a product being associated with the product code. In the example of the present Figure, since arrangement of a product at an introduction destination is indicated on the display panel 30 as arrangement of the display region 310, work can be done efficiently.

A clerk viewing the display panel 30 introduces the product in response to the display. Then, when work displayed on the display panel 30 is finished, the clerk performs, on the clerk terminal 50, input indicating that the work is finished, as in step S11. Accordingly, switch information based on input to the clerk terminal 50 is transmitted from the clerk terminal 50 to the control apparatus 40. When accepting the switch information (step S21), the display data generation unit 450 finishes processing. Note that, when there are a plurality of products extracted in step S20, the display data generation unit 450 accepting the switch information generates display data for displaying change information indicating introducing a next product. Then, processing transfers to step S22 at a point where change information regarding all products extracted in step S20 is displayed, and switch information is accepted.

In step S22, the display data generation unit 450 switches a display content on the display panel 30 from a display content for a clerk to a display content for a customer. Herein, the display content for a customer after switch includes price label information after an exhibition change based on the second exhibition data. Note that, a price or the like in product information may also be updated in addition to arrangement of a product. The display data generation unit 450 may acquire new product information, and display, on the display panel 30, price label information after change, based on the product information.

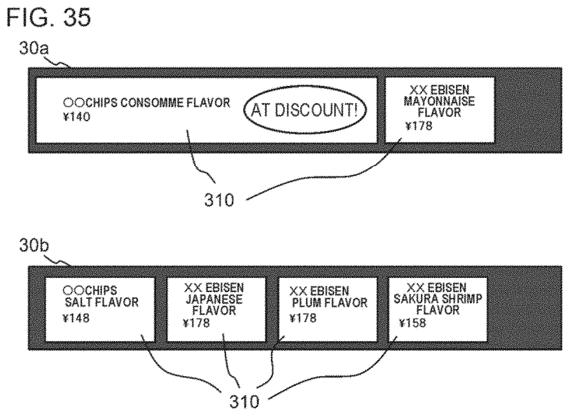

FIG. 35 is a diagram illustrating a display content for a customer after an exhibition change.

In the processing described above, the control apparatus 40 may switch a color of at least part of a display content for a clerk, based on a kind of a work content. For example, at least one of a background color, a character color, and a color of a frame of the display region 310 displaying change information can be differed from one another among “reduction of a face”, “enlargement of a face”, “takeout of a product”, “introduction of a product”, and “movement of a product”. Thus, a clerk can intuitively recognize a work content.

Next, an advantage and an effect according to the present example embodiment are described. In the present example embodiment, an advantage and an effect similar to those according to the first example embodiment can be acquired. In addition, support for work of a clerk becomes possible by a display on the display panel 30.

### Fourth Example Embodiment

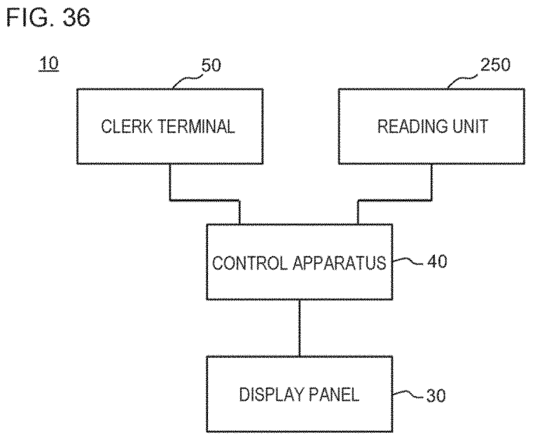

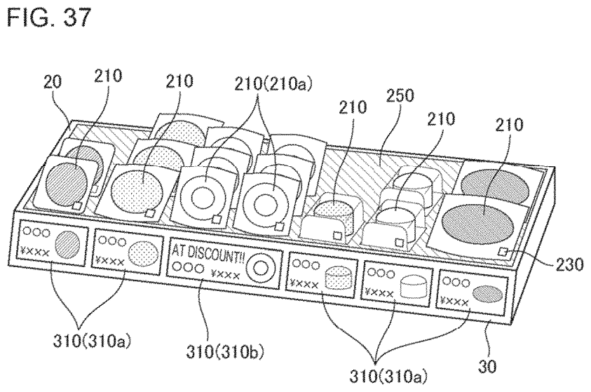

FIG. 36 is a diagram illustrating a configuration of a system 10 according to a fourth example embodiment. FIG. 37 is a diagram illustrating a use environment and a display content of a display panel 30 according to the fourth example embodiment. The system 10 and a control apparatus 40 according to the present example embodiment are the same as the system 10 and the control apparatus 40 according to the third example embodiment, respectively, except for a point described below.

The system 10 according to the present example embodiment includes a reading unit 250. A wireless communication tag 230 is attached to a product 210. A shelf 20 is provided with the reading unit 250 of the wireless communication tag 230. Then, switch information is information based on a reading result by the reading unit 250. Description is given in detail below.

The wireless communication tag 230 is, for example, a radio frequency identifier (RFID), and the reading unit 250 is an RFID reader. The wireless communication tag 230 saves product identification information (ID) of the product 210 to which the wireless communication tag 230 is attached. The reading unit 250 is, for example, sheet-shaped, and is laid on a product arrangement surface 201 of the shelf 20. In this case, the reading unit 250 is located between the shelf 20 and the product 210. Then, the reading unit 250 can read the product identification information from the wireless communication tag 230. The product identification information is given to, for example, each product 210. On the other hand, a storage unit 440 saves product management data. The product management data are, for example, data indicating an inventory state of the product 210 in a store. The product management data include a plurality of pieces of the product identification information. Further, the product management data include a product code, an exhibition time limit, and the like being associated with each piece of the product identification information.

The control apparatus 40 is connected to the reading unit 250 via a network interface 1120 or an input-output interface 1100. An acquisition unit 410 of the control apparatus 40 can acquire a reading result of the wireless communication tag 230, that is, product identification information from the reading unit 250.

Processing performed by a display data generation unit 450 according to the present example embodiment in order to display a display content for a clerk on the display panel 30 can be illustrated by a flowchart similar to that in FIG. 26. However, the display data generation unit 450 can switch change information that is displayed on the display panel 30, based on a reading result by the reading unit 250.

In the present example embodiment, when the display data generation unit 450 displays change information on the display panel 30, a clerk does work such as movement, takeout, and introduction of the product 210 in response to the display content. During the work, that is, while change information is displayed, the reading unit 250 reads product identification information from the wireless communication tag 230 of the product 210 arranged on the shelf 20, and transmits the read product identification information to the control apparatus 40. When acquiring the product identification information, the display data generation unit 450 collates the acquired product identification information with product management data read from the storage unit 440, and extracts a product code of the product. Further, the control apparatus 40 can acquire, from the reading unit 250, information indicating which position of the shelf 20 each of the wireless communication tags 230 is detected at. Thus, the number and arrangement of the products 210 of each product code on the shelf 20 are determined in the display data generation unit 450. Then, the display data generation unit 450 can monitor whether work on the product 210 is done as in the change information displayed on the display panel 30.

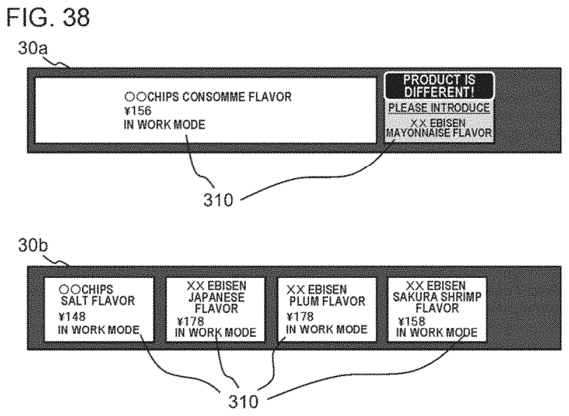

FIG. 38 is a diagram illustrating the display panel 30 on which a caution is displayed. For example, when change work is done for a product that does not need a change, or a product different from a product to be introduced is introduced, the display data generation unit 450 displays a caution on the display panel 30. Thus, a work mistake or the like is suppressed, and work time of a clerk can be shortened.

In steps S11, 13, 15, 17, 19, and 21, the display data generation unit 450 determines, based on a reading result by the reading unit 250, whether the work indicated in the change information is completed. When the display data generation unit 450 determines that the work is completed, processing is advanced to a next step. Specifically, when arrangement of a product on the shelf 20 is brought into a state after change based on each piece of change information, the display data generation unit 450 determines that the work is completed. Thus, a clerk can switch change information without operating a clerk terminal 50.

Note that, even when the display data generation unit 450 does not determine, based on a reading result by the reading unit 250, that the work is completed, the display data generation unit 450 may switch change information that is displayed on the display panel 30, when input indicating that work is finished is performed on the clerk terminal 50 as described in the third example embodiment.

Next, an advantage and an effect according to the present example embodiment are described. In the present example embodiment, an advantage and an effect similar to those according to the first example embodiment can be acquired. In addition, exhibition change work can be enhanced in efficiency.

### Fifth Example Embodiment

A system 10 and a control apparatus 40 according to a fifth example embodiment are the same as the system 10 and the control apparatus 40 according to the fourth example embodiment, respectively, except for a point described below.

In the system 10 according to the present example embodiment, a display content for a clerk includes information indicating presence or absence of a product with an expired exhibition time limit. Support of exhibition time limit management of a product is possible. For a product in a store, an exhibition time limit based on, for example, a best-before date or the like of food is determined. Product identification information is given to, for example, each product, and an exhibition time limit is included in product management data as described in the fourth example embodiment. A display data generation unit 450 can determine an exhibition time limit of each product arranged on a shelf 20, by collating a reading result acquired from a reading unit 250 with the product management data.

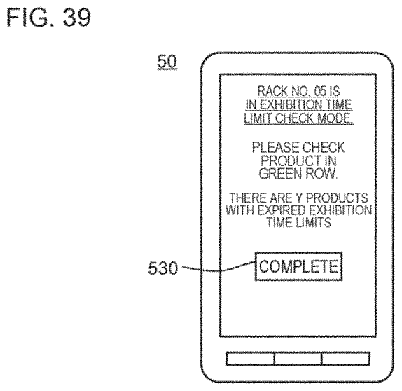

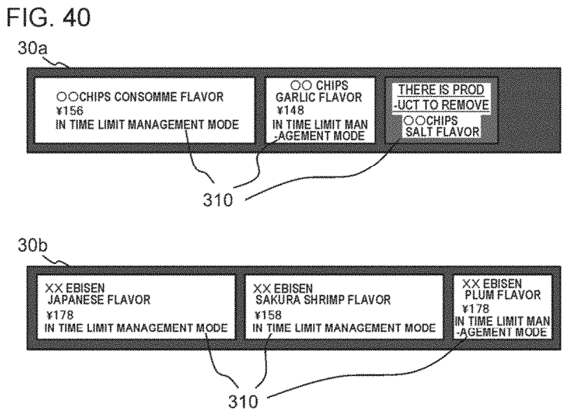

FIG. 39 is a diagram illustrating a display screen of a clerk terminal 50 for managing an exhibition time limit. FIG. 40 is a diagram illustrating a display panel 30 on which a display encouraging takeout of a product is performed. A clerk can start a time limit management mode by specifying display fixture identification information and performing, on the clerk terminal 50, a change operation to the time limit management mode. When the time limit management mode starts, the display data generation unit 450 determines, based on a reading result by the reading unit 250 and product management data, an exhibition time limit of a product arranged on each shelf 20 of a display fixture 220. Then, the display data generation unit 450 determines whether each of the determined exhibition time limits is before a current date and time. When determining that the exhibition time limit is before the current date and time, the display data generation unit 450 displays, on the display panel 30, a display content encouraging takeout of a product with the exhibition time limit, as illustrated in FIG. 40. In the example of the present Figure, a display encouraging work is performed in a display region 310 of a row where a product with an expired exhibition time limit to be taken out exists. The number and a position of products to be taken out may be further displayed in at least one of the display panel 30 and the clerk terminal 50. As in FIG. 39, a work content to be done by a clerk may be displayed on the clerk terminal 50.

A clerk searches for a product with an expired time limit and takes out the product from the shelf 20, in response to the display in the display panel 30. When all products 210 with expired time limits are taken out, the display data generation unit 450 determines, based on a reading result by the reading unit 250, that the work is completed, and finishes the time limit management mode. Further, when a clerk performs, on the clerk terminal 50, an operation (e.g., tapping of a completion button 530) indicating that the work is completed, the time limit management mode may be finished. Note that, processing necessary for product management data, such as disposal registration, may be performed on the spot.

Next, an advantage and an effect according to the present example embodiment are described. In the present example embodiment, an advantage and an effect similar to those according to the first example embodiment can be acquired. In addition, management of an exhibition time limit can be performed efficiently and correctly.

While the example embodiments of the present invention have been described above with reference to the drawings, the example embodiments are illustrations of the present invention, and various configurations other than those described above can also be adopted. For example, although a plurality of steps (processing) are described in order in a sequence diagram and a flowchart used in the above description, an execution order of the steps executed in each example embodiment is not limited to the described order. In each example embodiment, an order of illustrated steps can be modified within a scope that is not disadvantageous in terms of a content. The example embodiments described above can be combined within a scope that is not inconsistent in a content.

While the example embodiments of the present invention have been described above with reference to the drawings, the example embodiments are illustrations of the present invention, and various configurations other than those described above can also be adopted.

The whole or part of the example embodiments disclosed above can be described as, but not limited to, the following supplementary notes.

1-1. A system including:

a display panel placed on a shelf; and

a control apparatus that controls a display content of the display panel, wherein

the control apparatus switchingly displays a display content for a clerk and a display content for a customer on the display panel.

1-2. The system according to supplementary note 1-1., wherein
the display content for a clerk includes change information indicating a change in arrangement of a product on the shelf.
   1-3. The system according to supplementary note 1-2., wherein

the control apparatus generates display data indicating the display content for a clerk, based on first exhibition data before a change in arrangement of the product, and second exhibition data after the change in arrangement of the product.

1-4. The system according to supplementary note 1-2. or 1-3., wherein

the control apparatus switches the change information, based on switch information indicating that a work content of the clerk is switched.

1-5. The system according to supplementary note 1-4., wherein

the switch information is information based on input to a clerk terminal.

1-6. The system according to supplementary note 1-4., wherein

a wireless communication tag is attached to the product,

the shelf is provided with a reading unit of the wireless communication tag, and

the switch information is information based on a reading result by the reading unit.

1-7. The system according to any one of supplementary notes 1-4. to 1-6., wherein

the control apparatus switches a color of at least part of the display content for a clerk, based on a kind of the work content.

1-8. The system according to any one of supplementary notes 1-1. to 1-7., wherein

the control apparatus switches between the display content for a clerk and the display content for a customer, based on input to a clerk terminal.

1-9. The system according to any one of supplementary notes 1-1. to 1-8., wherein

the display content for a customer includes one or more pieces of price label information.

1-10. The system according to supplementary note 1-9., wherein

a length of a long side of the display panel is twice or more than a length of a short side of the display panel, and

the control apparatus determines a display region for each piece of the price label information in the display panel by use of exhibition data of the shelf.

2-1. A control apparatus that controls a display content of a display panel placed on a shelf, including

switchingly displaying a display content for a clerk and a display content for a customer on the display panel.

2-2. The control apparatus according to supplementary note 2-1., wherein

the display content for a clerk includes change information indicating a change in arrangement of a product on the shelf.

2-3. The control apparatus according to supplementary note 2-2., further including

generating display data indicating the display content for a clerk, based on first exhibition data before a change in arrangement of the product, and second exhibition data after the change in arrangement of the product.

2-4. The control apparatus according to supplementary note 2-2. or 2-3., further including

switching the change information, based on switch information indicating that a work content of the clerk is switched.

2-5. The control apparatus according to supplementary note 2-4., wherein

the switch information is information based on input to a clerk terminal.

2-6. The control apparatus according to supplementary note 2-4., wherein

a wireless communication tag is attached to the product,

the shelf is provided with a reading unit of the wireless communication tag, and

the switch information is information based on a reading result by the reading unit.

2-7. The control apparatus according to any one of supplementary notes 2-4. to 2-6., further including

switching a color of at least part of the display content for a clerk, based on a kind of the work content.

2-8. The control apparatus according to any one of supplementary notes 2-1. to 2-7., further including

switching between the display content for a clerk and the display content for a customer, based on input to a clerk terminal.

2-9. The control apparatus according to any one of supplementary notes 2-1. to 2-8., wherein

the display content for a customer includes one or more pieces of price label information.

2-10. The control apparatus according to supplementary note 2-9., wherein

a length of a long side of the display panel as twice or more than a length of a short side of the display panel, and

the control apparatus determined a display region for each piece of the price label information in the display panel by use of exhibition data of the shelf.

3-1. A computer program for achieving a control apparatus that controls a display content of a display panel placed on a shelf, the computer program causing a computer to function as

the control apparatus that switchingly displays a display content for a clerk and a display content for a customer on the display panel.

3-2. The computer program according to supplementary note 3-1., wherein

the display content for a clerk includes change information indicating a change in arrangement of a product on the shelf.

3-3. The computer program according to supplementary note 3-2., wherein

the control apparatus generates display data indicating the display content for a clerk, based on first exhibition data before a change in arrangement of the product, and second exhibition data after the change in arrangement of the product.

3-4. The computer program according to supplementary note 3-2. or 3-3., wherein

the control apparatus switches the change information, based on switch information indicating that a work content of the clerk is switched.

3-5. The computer program according to supplementary note 3-4., wherein

the switch information is information based on input to a clerk terminal.

3-6. The computer program according to supplementary note 3-4., wherein

a wireless communication tag is attached to the product,

the shelf is provided with a reading unit of the wireless communication tag, and

the switch information is information based on a reading result by the reading unit.

3-7. The computer program according to any one of supplementary notes 3-4. to 3-6., wherein

the control apparatus switches a color of at least part of the display content for a clerk, based on a kind of the work content.

3-8. The computer program according to any one of supplementary notes 3-1. to 3-7., wherein

the control apparatus switches between the display content for a clerk and the display content for a customer, based on input to a clerk terminal.

3-9. The computer program according to any one of supplementary notes 3-1. to 3-8., wherein

the display content for a customer includes one or more pieces of price label information.

3-10. The computer program according to supplementary note 3-9., wherein

a length of a long side of the display panel is twice or more than a length of a short side of the display panel, and

the control apparatus determines a display region for each piece of the price label information in the display panel by use of exhibition data of the shelf.

4-1. A control method of controlling a display content of a display panel placed on a shelf, the control method including

by a computer, switchingly displaying a display content for a clerk and a display content for a customer on the display panel.

4-2. The control method according to supplementary note 4-1., wherein

the display content for a clerk includes change information indicating a change in arrangement of a product on the shelf.

4-3. The control method according to supplementary note 4-2., further including

by the computer, generating display data indicating the display content for a clerk, based on first exhibition data before a change in arrangement of the product, and second exhibition data after the change in arrangement of the product.

4-4. The control method according to supplementary note 4-2. or 4-3., further including

by the computer, switching the change information, based on switch information indicating that a work content of the clerk is switched.

4-5. The control method according to supplementary note 4-4., wherein

the switch information is information based on input to a clerk terminal.

4-6. The control method according to supplementary note 4-4., wherein

a wireless communication tag is attached to the product,

the shelf is provided with a reading unit of the wireless communication tag, and

the switch information is information based on a reading result by the reading unit.

4-7. The control method according to any one of supplementary notes 4-4. to 4-6., further including

by the computer, switching a color of at least part of the display content for a clerk, based on a kind of the work content.

4-8. The control method according to any one of supplementary notes 4-1. to 4-7., further including

by the computer, switching between the display content for a clerk and the display content for a customer, based on input to a clerk terminal.

4-9. The control method according to any one of supplementary notes 4-1. to 4-8., wherein

the display content for a customer includes one or more pieces of price label information.

4-10. The control method according to supplementary note 4-9., wherein

a length of a long side of the display panel as twice or more than a length of a short side of the display panel, and

the control method further including, by the computer, determining a display region for each piece of the price label information in the display panel by use of exhibition data of the shelf.

5-1. A system including:

a display panel placed on a shelf; and

a control apparatus that controls a display content of the display panel, wherein

the control apparatus generates display data indicating a display content for a clerk that is displayed on the display panel, based on first exhibition data before a change in arrangement of a product on the shelf, and second exhibition data after change.

5-2. The system according to supplementary note 5-1., wherein

the display content for a clerk includes change information indicating a change in arrangement of a product on the shelf.

5-3. The system according to supplementary note 5-2., wherein

the control apparatus switches the change information, based on switch information indicating that a work content of the clerk is switched.

5-4. The system according to supplementary note 5-3., wherein

the switch information is information based on input to a clerk terminal.

5-5. The system according to supplementary note 5-3., wherein

a wireless communication tag is attached to the product,

the shelf is provided with a reading unit of the wireless communication tag, and

the switch information is information based on a reading result by the reading unit.

5-6. The system according to any one of supplementary notes 5-3. to 5-5., wherein

the control apparatus switches a color of at least part of the display content for a clerk, based on a kind of the work content.

6-1. A control apparatus that controls a display content of a display panel placed on a shelf, including

generating display data indicating a display content for a clerk that is displayed on the display panel, based on first exhibition data before a change in arrangement of a product on the shelf, and second exhibition data after change.

6-2. The control apparatus according to supplementary note 6-1., wherein

the display content for a clerk includes change information indicating a change in arrangement of a product on the shelf.

6-3. The control apparatus according to supplementary note 6-2., further including

switching the change information, based on switch information indicating that a work content of the clerk is switched.

6-4. The control apparatus according to supplementary note 6-3., wherein

the switch information is information based on input to a clerk terminal.

6-5. The control apparatus according to supplementary note 6-3., wherein

a wireless communication tag is attached to the product,

the shelf is provided with a reading unit of the wireless communication tag, and

the switch information is information based on a reading result by the reading unit.

6-6. The control apparatus according to any one of supplementary notes 6-3. to 6-5., further including

switching a color of at least part of the display content for a clerk, based on a kind of the work content.

7-1. A computer program for achieving a control apparatus that controls a display content of a display panel placed on a shelf, the computer program causing a computer to function as

the control apparatus that generates display data indicating a display content for a clerk that is displayed on the display panel, based on first exhibition data before a change in arrangement of a product on the shelf, and second exhibition data after change.

7-2. The computer program according to supplementary note 7-1., wherein

the display content for a clerk includes change information indicating a change in arrangement of a product on the shelf.

7-3. The computer program according to supplementary note 7-2., wherein

the control apparatus switches the change information, based on switch information indicating that a work content of the clerk is switched.

7-4. The computer program according to supplementary note 7-3., wherein

the switch information is information based on input to a clerk terminal.

7-5. The computer program according to supplementary note 7-3., wherein

a wireless communication tag is attached to the product,

the shelf is provided with a reading unit of the wireless communication tag, and

the switch information is information based on a reading result by the reading unit.

7-6. The computer program according to any one of supplementary notes 7-3. to 7-5., wherein

the control apparatus switches a color of at least part of the display content for a clerk, based on a kind of the work content.

8-1. A control method of controlling a display content of a display panel placed on a shelf, the control method including

by a computer, generating display data indicating a display content for a clerk that is displayed on the display panel, based on first exhibition data before a change in arrangement of a product on the shelf, and second exhibition data after change.

8-2. The control method according to supplementary note 8-1., wherein

the display content for a clerk includes change information indicating a change in arrangement of a product on the shelf.

8-3. The control method according to supplementary note 8-2., further including

by the computer, switching the change information, based on switch information indicating that a work content of the clerk is switched.

8-4. The control method according to supplementary note 8-3., wherein

the switch information is information based on input to a clerk terminal.

8-5. The control method according to supplementary note 8-3., wherein

a wireless communication tag is attached to the product,

the shelf is provided with a reading unit of the wireless communication tag, and

the switch information is information based on a reading result by the reading unit.

8-6. The control method according to any one of supplementary notes 8-3. to 8-5., further including

by the computer, switching a color of at least part of the display content for a clerk, based on a kind of the work content.

9-1. A system including:

a display panel placed on a shelf; and

a control apparatus that controls a display content of the display panel, wherein

the control apparatus determines a display region for price label information in the display panel by use of exhibition data of the shelf.

9-2. The system according to supplementary note 9-1., wherein

a length of a long side of the display panel is twice or more than a length of a short side of the display panel.

10-1. A control apparatus that controls a display content of a display panel placed on a shelf; including

determining a display region for price label information in the display panel by use of exhibition data of the shelf.

10-2. The control apparatus according to supplementary note 10-1., wherein

a length of a long side of the display panel is twice or more than a length of a short side of the display panel.

11-1. A computer program for achieving a control apparatus that controls a display content of a display panel placed on a shelf, the computer program causing a computer to function as

the control apparatus that determines a display region for price label information in the display panel by use of exhibition data of the shelf.

11-2. The computer program according to supplementary note 11-1., wherein

a length of a long side of the display panel is twice or more than a length of a short side of the display panel.

12-1. A control method of controlling a display content of a display panel placed on a shelf, the control method including

by a computer, determining a display region for price label information in the display panel by use of exhibition data of the shelf.

12-2. The control method according to supplementary note 12-1., wherein

a length of a long side of the display panel is twice or more than a length of a short side of the display panel.

This application is based upon and claims the benefit of priority from Japanese Patent Application No. 2018-232701, filed on Dec. 12, 2018, the disclosure of which is incorporated herein in its entirety by reference.

What is claimed is:

1. A system comprising:
a display panel placed on a shelf; and
a control apparatus that controls a display content of the display panel, wherein
the control apparatus switchingly displays a display content for a clerk and a display content for a customer on the display panel.

2. The system according to claim 1, wherein
the display content for a clerk includes change information indicating a change in arrangement of a product on the shelf.

3. The system according to claim 2, wherein
the control apparatus generates display data indicating the display content for a clerk, based on first exhibition data before a change in arrangement of the product, and second exhibition data after the change in arrangement of the product.

4. The system according to claim 2, wherein
the control apparatus switches the change information, based on switch information indicating that a work content of the clerk is switched.

5. The system according to claim 4, wherein
the switch information is information based on input to a clerk terminal.

6. The system according to claim 4, wherein
a wireless communication tag is attached to the product,
the shelf is provided with reading unit of the wireless communication tag, and
the switch information is information based on a reading result by the reading unit.

7. The system according to claim 4, wherein
the control apparatus switches a color of at least part of the display content for a clerk, based on a kind of the work content.

8. The system according to claim 1, wherein
the control apparatus switches between the display content for a clerk and the display content for a customer, based on input to a clerk terminal.

9. The system according to claim 1, wherein
the display content for a customer includes one or more pieces of price label information.

10. The system according to claim 9, wherein
a length of a long side of the display panel is twice or more than a length of a short side of the display panel, and
the control apparatus determines a display region for each piece of the price label information in the display panel by use of exhibition data of the shelf.

11. A control apparatus that controls a display content of a display panel placed on a shelf, comprising
switchingly displaying a display content for a clerk and a display content for a customer on the display panel.

12. A non-transitory storage medium storing a computer program for achieving a control apparatus that controls a display content of a display panel placed on a shelf, the computer program causing a computer to function as
the control apparatus that switchingly displays a display content for a clerk and a display content for a customer on the display panel.

13. A control method of controlling a display content of a display panel placed on a shelf, the control method comprising
by a computer, switchingly displaying a display content for a clerk and a display content for a customer on the display panel.
